(19) United States
(12) Patent Application Publication
(10) Pub. No.: US 2025/0324059 A1
(43) Pub. Date: Oct. 16, 2025

(54) VIDEO PROCESSING METHOD AND APPARATUS, COMPUTER DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Shenming FENG, Shenzhen (CN); Sihong CHEN, Shenzhen (CN)

(21) Appl. No.: 19/199,974

(22) Filed: May 6, 2025

Related U.S. Application Data
(63) Continuation of application No. PCT/CN2024/078595, filed on Feb. 26, 2024.

(30) Foreign Application Priority Data
Apr. 19, 2023 (CN) 202310468833.X

(51) Int. Cl. H04N 19/132; H04N 19/136; H04N 19/167; H04N 19/172; H04N 19/177; H04N 19/186; H04N 19/20; H04N 19/60; H04N 19/70

(52) U.S. Cl. CPC H04N 19/132; H04N 19/136; H04N 19/167; H04N 19/172; H04N 19/177; H04N 19/186; H04N 19/20; H04N 19/60; H04N 19/70

(57) ABSTRACT

A video processing method includes obtaining video frame attribute information, and first- and second-type groups of pictures (GOPs) from a video, deleting non-reference frame(s) in the first-type GOP and non-reference frame(s) in the second-type GOP based on the attribute information to obtain first- and second-type reorganized GOPs, extracting instantaneous decoding refresh frame(s) from the first-type reorganized GOP to obtain a target GOP not including the instantaneous decoding refresh frame(s), performing sampling on the target GOP and the second-type reorganized GOP in response to a quantity of the instantaneous decoding refresh frame(s) not meeting a decoding condition to obtain or more sampled frame(s), and performing video frame decoding on the sampled frame(s) and the instantaneous decoding refresh frame(s) to obtain decoded frame(s).

### CROSS-REFERENCE TO RELATED APPLICATIONS

This application is a continuation of International Application No. PCT/CN2024/078595, filed on Feb. 26, 2024, which claims priority to Chinese Patent Application No. 202310468833.X, entitled “VIDEO PROCESSING METHOD AND APPARATUS, COMPUTER DEVICE, STORAGE MEDIUM, AND PROGRAM PRODUCT” filed with the China National Intellectual Property Administration on Apr. 19, 2023, the entire contents of both of which are incorporated by reference.

### FIELD OF THE TECHNOLOGY

This application relates to the field of video processing technologies, and in specific, to a video processing method and apparatus, a computer device, a storage medium, and a computer program product.

### BACKGROUND OF THE DISCLOSURE

With continuous development of video processing technologies and Internet technologies, various videos of interest can be conveniently obtained, and then the obtained videos can be correspondingly processed according to an actual processing task. For example, when the processing task is a video understanding task, sparse frame capture processing may be first performed on the videos, to accelerate processing of the video understanding task.

In a conventional solution of performing sparse frame capture processing on a video, video frames of the video are mainly uniformly sampled to obtain a specific video frame that is to be decoded and a dependent frame of the specific video frame. Then, the specific video frame and the corresponding dependent frame are decoded to obtain a target video on which sparse processing is performed. However, in the foregoing solution of performing sparse frame capture processing on the video, many video frames are unnecessarily decoded, resulting in low video decoding efficiency.

### SUMMARY

In accordance with the disclosure, there is provided a video processing method including obtaining video frame attribute information, a first-type group of pictures (GOP), and a second-type GOP from a video, deleting one or more non-reference frames in the first-type GOP and one or more non-reference frames in the second-type GOP based on the attribute information to obtain a first-type reorganized GOP and a second-type reorganized GOP, extracting one or more instantaneous decoding refresh frames from the first-type reorganized GOP to obtain the one or more instantaneous decoding refresh frames and a target GOP not including the one or more instantaneous decoding refresh frames, performing sampling on the target GOP and the second-type reorganized GOP in response to a quantity of the one or more instantaneous decoding refresh frames not meeting a decoding condition to obtain one or more sampled frames, and performing video frame decoding on the one or more sampled frames and the one or more instantaneous decoding refresh frames to obtain one or more decoded frames.

Also in accordance with the disclosure, there is provided a computer device including a processor and a memory storing a computer program that, when executed by the processor, causes the processor to obtain video frame attribute information, a first-type group of pictures (GOP), and a second-type GOP from a video, delete one or more non-reference frames in the first-type GOP and one or more non-reference frames in the second-type GOP based on the attribute information to obtain a first-type reorganized GOP and a second-type reorganized GOP, extract one or more instantaneous decoding refresh frames from the first-type reorganized GOP to obtain the one or more instantaneous decoding refresh frames and a target GOP not including the one or more instantaneous decoding refresh frames, perform sampling on the target GOP and the second-type reorganized GOP in response to a quantity of the one or more instantaneous decoding refresh frames not meeting a decoding condition to obtain one or more sampled frames, and perform video frame decoding on the one or more sampled frames and the one or more instantaneous decoding refresh frames to obtain one or more decoded frames.

Also in accordance with the disclosure, there is provided a computer-readable storage medium storing a computer program that, when executed by the processor, causes the processor to obtain video frame attribute information, a first-type group of pictures (GOP), and a second-type GOP from a video, delete one or more non-reference frames in the first-type GOP and one or more non-reference frames in the second-type GOP based on the attribute information to obtain a first-type reorganized GOP and a second-type reorganized GOP, extract one or more instantaneous decoding refresh frames from the first-type reorganized GOP to obtain the one or more instantaneous decoding refresh frames and a target GOP not including the one or more instantaneous decoding refresh frames, perform sampling on the target GOP and the second-type reorganized GOP in response to a quantity of the one or more instantaneous decoding refresh frames not meeting a decoding condition to obtain one or more sampled frames, and perform video frame decoding on the one or more sampled frames and the one or more instantaneous decoding refresh frames to obtain one or more decoded frames.

### BRIEF DESCRIPTION OF THE DRAWINGS

FIG. 1 is a diagram showing an application environment of a video processing method according to an embodiment.

FIG. 2A is a schematic flowchart of a video processing method according to an embodiment.

FIG. 2B is a schematic flowchart of a video processing method according to another embodiment.

FIG. 3 is a schematic diagram showing a closed GOP and an open GOP according to an embodiment.

FIG. 4 is a schematic diagram showing a change of a closed GOP before and after bitstream reorganization is performed on the GOP according to an embodiment.

FIG. 5 is a schematic diagram showing extracting an IDR frame from a reorganized GOP to obtain an IDR frame sequence and a non-IDR frame sequence according to an embodiment.

FIG. 6 is a schematic diagram showing sampling in a non-IDR frame sequence according to an embodiment.

FIG. 7 is a schematic diagram showing classifying decoded frames by using a video classification model according to an embodiment.

FIG. 8 is a schematic flowchart of obtaining, by recognizing a decoded frame, description information corresponding to a target object in a video according to an embodiment.

FIG. 9 is a schematic diagram showing displaying a target object in a highlight manner according to an embodiment.

FIG. 10 is a schematic diagram showing displaying a search entry and object description information according to an embodiment.

FIG. 11 is a schematic flowchart of a video processing method according to another embodiment.

FIG. 12 is a schematic diagram showing performing video processing and classification by using an existing frame capture method and in a frame capture manner in this application according to an embodiment.

FIG. 13 is a block diagram showing a structure of a video processing apparatus according to an embodiment.

FIG. 14 is a block diagram showing a structure of a video processing apparatus according to an embodiment.

FIG. 15 is a diagram showing an internal structure of a computer device according to an embodiment.

### DESCRIPTION OF EMBODIMENTS

To make objectives, technical solutions, and advantages of this application clearer and more comprehensible, the following further describes this application in detail with reference to the accompanying drawings and embodiments. Specific embodiments described herein are only used for explaining this application, and are not used for limiting this application.

In the following descriptions, related terms “first, second, and third” are merely intended to distinguish between similar objects, and do not indicate a specific order for the objects. The “first, second, and third” may exchange specific orders or precedence orders as permitted, so that the embodiments of this application described herein can be implemented in orders other than the order shown or described herein.

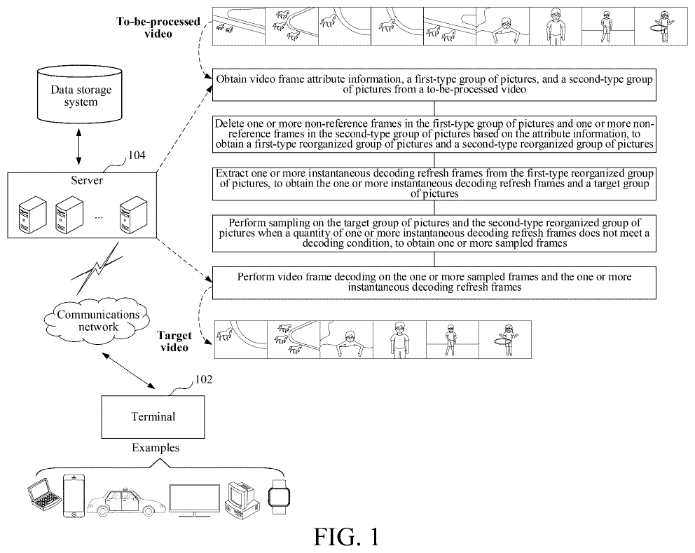

A video processing method provided in the embodiments of this application may be applied to an application environment shown in FIG. 1. A terminal 102 communicates with a server 104 through a network. A data storage system may store data that the server 104 needs to process. The data storage system may be integrated onto the server 104, or may be placed on a cloud or another network server.

A video processing system may be deployed on the terminal 102 or the server 104. Video processing may be performed on a to-be-processed video (also referred to as a “candidate video”) by using the video processing system, to implement sparsification of the to-be-processed video. In this way, a simplified target video that can completely express an original semantic of the to-be-processed video is obtained. The target video is a video including decoded frames obtained through sparsification.

The terminal 102 may be a smartphone, a tablet computer, a notebook computer, a desktop computer, a smart speaker, an Internet of Things (IoT) device, or a portable wearable device. The Internet of Things device may be a smart speaker, a smart television, an intelligent air conditioner, an intelligent vehicle-mounted device, or the like. The portable wearable device may be a smart watch, a smart band, a head-mounted device, or the like.

The server 104 may be an independent physical server, or may be a service node in a blockchain system. Service nodes in the blockchain system form a peer-to-peer (P2P) network. A P2P protocol is an application-layer protocol running over a transmission control protocol (TCP). In addition, the server 104 may alternatively be a server cluster including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The terminal 102 may be connected to the server 104 in a communication connection manner such as Bluetooth, a universal serial bus (USB), or a network. This is not limited in this application.

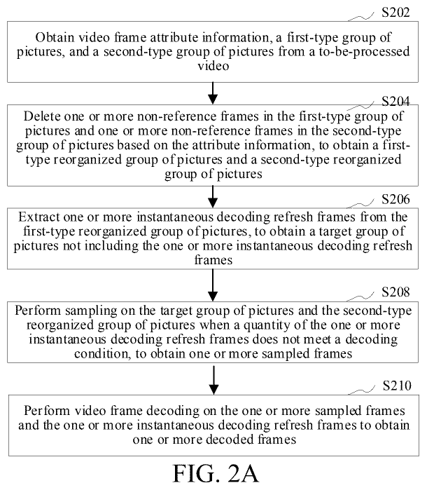

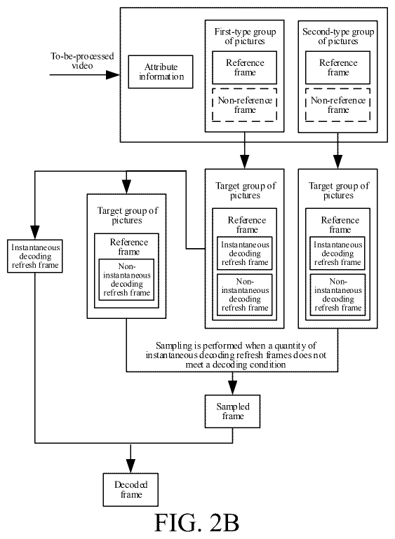

In an embodiment, as shown in FIG. 2A and FIG. 2B, a video processing method is provided. The method may be performed by the server or the terminal in FIG. 1, or may be cooperatively performed by the server and the terminal. An example in which the method is performed by the terminal in FIG. 1 is used for description, and the method includes the following operations.

S202: Obtain video frame attribute information, a first-type group of pictures, and a second-type group of pictures from a to-be-processed video.

The to-be-processed video may be a video that needs to be processed, and specifically, may be a short video, a medium video, or a long video. During actual application, the to-be-processed video may be a sports video, a conference video, an entertainment video, a game video, or another type of video.

The video frame may be each frame of image forming the to-be-processed video. The attribute information may be information configured for describing the video frame, and includes: first attribute information configured for distinguishing between an instantaneous decoding refresh frame and a non-instantaneous decoding refresh frame, and second attribute information configured for distinguishing between a reference frame and a non-reference frame. The second attribute information may be nal_ref_idc, where nal_ref_idc is an important component in each network abstraction layer unit (NALU), and may represent importance of the NALU. For example, nal_ref_idc=0 represents that the video frame is a non-reference frame, and can be discarded during decoding. nal_ref_idc!=0 represents that the video frame is a reference frame, and cannot be discarded during decoding.

A group of pictures (GOP) is a set including a group of consecutive video frames. The video frames in the GOP have a high similarity between each other. One video may include a plurality of GOPs. In an encoded sequence of a video, there are mainly three types of encoded frames, that is, an I-frame, a P-frame, and a B-frame. The 1^{st} frame of the GOP is the I-frame, and the I-frame is classified into two types: an instantaneous decoding refresh (IDR) frame and a non-IDR frame. The IDR frame is a key frame not depending on another video frame, and is encoded by using only information about this video frame. When the IDR frame is decoded, a decoder clears a reference frame queue, and re-establishes an empty reference frame queue. The non-IDR frame may depend on a video frame in a previous GOP during decoding. Generally, when picture content of a video frame greatly changes, an I-frame needs to be obtained through re-encoding. The P-frame depends on a previous I-frame or P-frame during decoding and performs inter-frame predictive encoding in a manner of motion estimation. The B-frame can provide a highest compression ratio, and depends on previous and following reference frames during decoding. The I-frame and the P-frame may be used as reference frames.

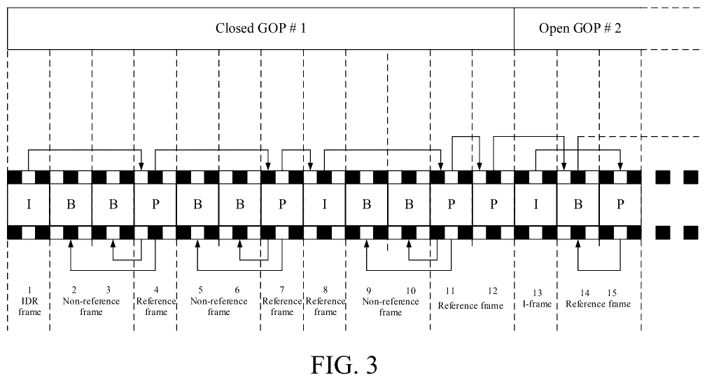

The first-type group of pictures may refer to a closed group of pictures (which is referred to as a closed GOP for short), to be specific, a group of pictures whose 1^{st} frame is an instantaneous decoding refresh frame. A video frame in the closed group of pictures depends on only another frame in the group during decoding. As shown in FIG. 3, for a left GOP on FIG. 3, because the 1^{st} frame of the GOP is an IDR frame, the GOP is a closed GOP.

The second-type group of pictures may refer to an open group of pictures (which is referred to as an open GOP for short), to be specific, a group of pictures whose 1^{st} frame is a non-instantaneous decoding refresh frame. A video frame in the open GOP may depend on a reference frame in a previous GOP during decoding. As shown in FIG. 3, for a right GOP on FIG. 3, because the 1^{st} frame of the GOP is not an IDR frame, the GOP is an open GOP.

In an embodiment, a terminal parses the to-be-processed video to obtain the attribute information and at least two groups of pictures. The attribute information includes the first attribute information configured for distinguishing between the instantaneous decoding refresh frame and the non-instantaneous decoding refresh frame. The terminal performs group type recognition on the at least two groups of pictures based on the first attribute information, to obtain the first-type group of pictures including the one or more instantaneous decoding refresh frames and the second-type group of pictures including one or more non-instantaneous decoding refresh frames.

Before performing parsing, the terminal may first receive an inputted video stream of the to-be-processed video, and then perform bitstream parsing on the video stream of the to-be-processed video, to obtain the attribute information and the at least two groups of pictures.

For example, the terminal performs bitstream parsing on the video stream of the to-be-processed video to obtain attribute information nal_ref_idc, and may determine distribution of a closed GOP and an open GOP based on nal_ref_idc, to obtain the closed GOP and the open GOP.

Operations of obtaining the first-type group of pictures and the second-type group of pictures may specifically include: The terminal determines position information of the one or more instantaneous decoding refresh frames based on the first attribute information; determines distribution information of different types of groups of pictures based on the position information of the one or more instantaneous decoding refresh frames; and select, based on the distribution information, the first-type group of pictures including the one or more instantaneous decoding refresh frames and the second-type group of pictures including the one or more non-instantaneous decoding refresh frames from the at least two groups of pictures.

S204: Delete one or more non-reference frames in the first-type group of pictures and one or more non-reference frames in the second-type group of pictures based on the attribute information, to obtain a first-type reorganized group of pictures and a second-type reorganized group of pictures.

The non-reference frame may refer to a frame that is not a dependent frame of another video frame during decoding. To be specific, a decoding process can be completed without depending on this non-reference frame when the another video frame is decoded. During actual application, both the P-frame and the B-frame may be used as non-reference frames. Both the P-frame and the B-frame may be used as the non-reference frames, but not all P-frames and B-frames are used as non-reference frames.

For example, as shown in FIG. 3, decoding of any one of the 1^{st} to 15^{th} video frames does not depend on the 2^{nd}, 3^{rd}, 5^{th}, 6^{th}, 9^{th}, and 10^{th} frames. Therefore, the 2^{nd}, 3^{rd}, 5^{th}, 6^{th}, 9^{th}, and 10^{th} frames are non-reference frames. In other words, if a video frame A is a non-reference frame, no video frame in the to-be-processed video depends on the video frame A during decoding, that is, the video frame A is not a dependent frame of any other video frame in the to-be-processed video.

Correspondingly, the reference frame may refer to a frame that can serve as a dependent frame of another video frame during decoding. To be specific, this reference frame needs to be depended on to complete a decoding process when another video frame is decoded. For example, as shown in FIG. 3, when the 4^{th} frame is decoded, the 1^{st} frame needs to be depended on to complete decoding. Therefore, the 1^{st} frame is a reference frame. Similarly, the 4^{th}, 7^{th}, 8^{th}, and 11^{th} to 15^{th} frames are all reference frames. In other words, if a video frame B is a reference frame, during decoding, the video frame B is a dependent frame of a video frame in the to-be-processed video, that is, when the video frame in the to-be-processed video is decoded, the video frame B needs to be depended on to complete decoding.

In an embodiment, the attribute information includes second attribute information configured for distinguishing between the reference frame and the non-reference frame. Therefore, S204 may specifically include: finding the one or more non-reference frames in the first-type group of pictures and the one or more non-reference frames in the second-type group of pictures based on the second attribute information; and deleting the one or more non-reference frames in the first-type group of pictures and the one or more non-reference frames in the second-type group of pictures to obtain the first-type reorganized group of pictures and the second-type reorganized group of pictures.

For example, a video frame whose attribute information nal_ref_idc=0 is found in the first-type group of pictures and the second-type group of pictures, and the video frame whose nal_ref_idc=0 is a non-reference frame. In this case, the video frame whose nal_ref_idc=0 may be deleted from the first-type group of pictures and the second-type group of pictures.

Specific operations of obtaining the first-type reorganized group of pictures and the second-type reorganized group of pictures includes: The terminal deletes the one or more non-reference frames in the first-type group of pictures, and establishes a binding relationship for video frames in the first-type group of pictures from which the one or more non-reference frames are deleted (i.e., establishing a binding relationship for remaining video frames in the first-type group of pictures), to obtain the first-type reorganized group of pictures; and deletes the one or more non-reference frames in the second-type group of pictures, and establishes a binding relationship for video frames in the second-type group of pictures from which the one or more non-reference frames are deleted (i.e., establishing a binding relationship for remaining video frames in the second-type group of pictures), to obtain the second-type reorganized group of pictures.

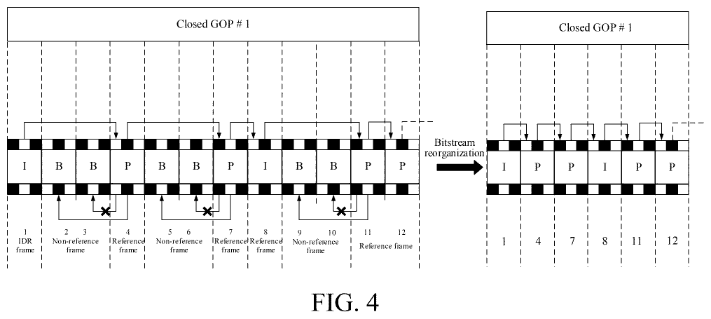

For example, FIG. 4 is a schematic diagram showing a change of a closed GOP before and after bitstream reorganization is performed on the GOP. During decoding, any video frame in the closed GOP does not depend on the 2^{nd}, 3^{rd}, 5^{th}, 6^{th}, 9^{th}, and 10^{th} frames, that is, the 2^{nd}, 3^{rd}, 5^{th}, 6^{th}, 9^{th}, and 10^{th} frames are non-reference frames. Therefore, the 2^{nd}, 3^{rd}, 5^{th}, 6^{th}, 9^{th}, and 10^{th} frames may be deleted from the closed GOP to complete decoupling of the non-reference frames, and then reserved video frames are combined to obtain a reorganized closed GOP.

S206: Extract one or more instantaneous decoding refresh frames from the first-type reorganized group of pictures, to obtain a target group of pictures not including the one or more instantaneous decoding refresh frames.

Specifically, the terminal extracts the one or more instantaneous decoding refresh frames from the first-type reorganized group of pictures based on the first attribute information. The first attribute information may be configured for distinguishing between the instantaneous decoding refresh frame and the non-instantaneous decoding refresh frame.

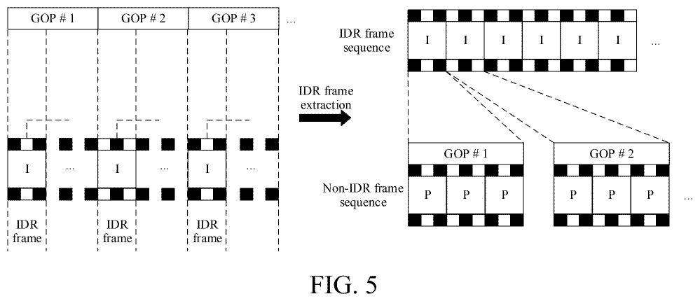

After all instantaneous decoding refresh frames of the to-be-processed video are extracted from the first-type reorganized group of pictures, the terminal may combine the extracted one or more instantaneous decoding refresh frames, to obtain a second video frame sequence. As shown in FIG. 5, because the second video frame sequence is a sequence formed by the instantaneous decoding refresh frames, the second video frame sequence may also be referred to as an instantaneous decoding refresh frame sequence.

In addition, after all the instantaneous decoding refresh frames of the to-be-processed video are extracted from the first-type reorganized group of pictures, the terminal may further combine the second-type reorganized group of pictures with the first-type reorganized group of pictures (that is, the target group of pictures) from which the instantaneous decoding refresh frames are extracted, to obtain a first video frame sequence. As shown in FIG. 5, because the first video frame sequence is a sequence formed by reference frames other than the instantaneous decoding refresh frames, the first video frame sequence may also be referred to as a non-instantaneous decoding refresh frame sequence.

S208: Perform sampling on the target group of pictures and the second-type reorganized group of pictures when a quantity of the one or more instantaneous decoding refresh frames does not meet a decoding condition, to obtain one or more sampled frames.

The decoding condition may be a minimum quantity of video frames during decoding. The quantity of video frames may be a quantity of captured frames that is preset by a user based on an actual requirement. Therefore, the quantity of video frames may also be referred to as a preset frame quantity.

In an embodiment, the terminal determines whether the quantity of the instantaneous decoding refresh frames meets the decoding condition, and if the quantity does not meet the decoding condition, the terminal performs sampling on the target group of pictures and the second-type reorganized group of pictures to obtain the one or more sampled frames. Sampling may be performed in a random sampling manner or a uniform sampling manner. When the sampling is performed in the uniform sampling manner, decoded video frames can be evenly distributed at various positions of the to-be-processed video, to avoid piling.

Specifically, after combining the target group of pictures with the second-type reorganized group of pictures and obtaining the first video frame sequence, the terminal determines whether the quantity of the instantaneous decoding refresh frames is greater than or equal to the preset frame quantity. If the quantity of the instantaneous decoding refresh frames is less than the preset frame quantity, the terminal determines a difference between the preset frame quantity and the quantity of the instantaneous decoding refresh frames. The terminal performs sampling in the first video frame sequence based on the difference, to obtain sampled frames whose quantity is equal to the difference.

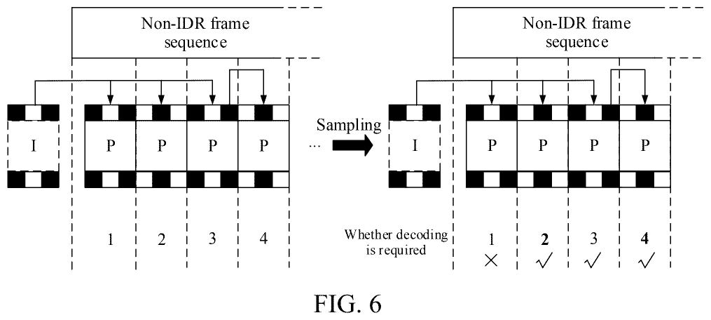

For example, as shown in FIG. 6, if a preset frame quantity is 100, and a quantity of extracted IDR frames is 60, a difference between the preset frame quantity and the quantity of extracted IDR frames is 40, and the terminal performs uniform sampling in a non-IDR frame sequence, to obtain 40 sampled frames.

During sampling, the terminal may preferentially sample the 1^{st} video frame in the first-type reorganized group of pictures from which the one or more instantaneous decoding refresh frames are extracted. In this case, a quantity of dependent frames may be reduced. When a sum of a quantity of sampled frames and the quantity of the instantaneous decoding refresh frames is equal to the preset frame quantity, S210 may be performed. When the sum of the quantity of the sampled frames and the quantity of the instantaneous decoding refresh frames is less than the preset frame quantity, the terminal continues to perform sampling in the second-type reorganized group of pictures until the sum of the quantity of the sampled frames and the quantity of the instantaneous decoding refresh frames is equal to the preset frame quantity. In this way, an important video frame of the to-be-processed video is captured, and then S210 is performed.

In an embodiment, the non-reference frame is a first-type non-reference frame, to be specific, the first-type non-reference frame refers to a non-reference frame of the to-be-processed video or each group of pictures. Therefore, an operation of performing sampling in the first video frame sequence based on the difference may specifically include: determining one or more second-type non-reference frames in the first video frame sequence; deleting the one or more second-type non-reference frames from the first video frame sequence, to obtain a new video frame sequence; and performing sampling in the new video frame sequence based on the difference. The second-type one or more non-reference frames are deleted from the first video frame sequence, so that non-reference frames are removed twice, to further reduce redundant frames and facilitate improving decoding efficiency.

After the one or more instantaneous decoding refresh frames are extracted from the first-type reorganized group of pictures, there may be a new non-reference frame in the first-type reorganized group of pictures from which the one or more instantaneous decoding refresh frames are extracted. Correspondingly, there may be a new non-reference frame in the first video frame sequence, and the new non-reference frame is the second-type non-reference frame. In this case, the second-type non-reference frame may be deleted from the first video frame sequence.

S210: Perform video frame decoding on the one or more sampled frames and the one or more instantaneous decoding refresh frames to obtain one or more decoded frames.

The quantity of the sampled frames may be N, and N is an integer greater than or equal to 2. In a process of performing video frame decoding, the terminal may perform video frame decoding on the sampled frames in a parallel manner, and then perform video frame decoding on the instantaneous decoding refresh frame, to obtain the corresponding decoded frame. In addition, the terminal may generate a target video based on the obtained decoded frame.

In an embodiment, after obtaining a sampled frame, the terminal may further determine whether the sampled frame has a dependent frame, and if yes, extract the dependent frame of the sampled frame, to capture a key video frame of the to-be-processed video. Then, video frame decoding is performed on the sampled frame, the instantaneous decoding refresh frame, and the dependent frame, to obtain the corresponding decoded frame. In addition, the terminal may generate a target video based on the obtained decoded frame.

For decoding the sampled frame, the instantaneous decoding refresh frame, and the dependent frame, specific decoding operations include: The terminal performs video frame decoding on the at least two instantaneous decoding refresh frames in a parallel manner; and sequentially performs video frame decoding on the dependent frame and the sampled frame in a serial manner.

The sampled frames may include at least a part of video frames (that is, a part of video frames or all video frames) that have corresponding dependent frames. The at least a part of video frames are referred to as a first part of sampled frames. Another part of video frames does not have corresponding dependent frames and are referred to as a second part of sampled frames.

Specifically, when the sampled frame has a corresponding dependent frame, and the dependent frame and the instantaneous decoding refresh frame are not the same frame, the terminal extracts the dependent frame of the sampled frame from at least one of the target group of pictures or the second-type reorganized group of pictures, and then performs video frame decoding on the sampled frame, the instantaneous decoding refresh frame, and the dependent frame.

In the first-type reorganized group of pictures, the instantaneous decoding refresh frame is a dependent frame of a next video frame of the instantaneous decoding refresh frame, that is, the next video frame depends on the instantaneous decoding refresh frame during decoding. When the next video frame is used as a sampled frame, even if the next video frame has the dependent frame, because the dependent frame is the instantaneous decoding refresh frame, the dependent frame does not need to be extracted. If the sampled frame is not the next video frame of the instantaneous decoding refresh frame, but is another video frame spaced apart from the next video frame, a dependent frame is not the same as the instantaneous decoding refresh frame. In this case, the corresponding dependent frame needs to be extracted.

For example, when sampled frames whose quantity is equal to the foregoing difference are obtained in the target group of pictures, the terminal may extract dependent frames of the sampled frames from the target group of pictures. Alternatively, when sampled frames whose quantity is equal to the foregoing difference are obtained in only the second-type reorganized group of pictures, the terminal may extract dependent frames of the sampled frames from the second-type reorganized group of pictures. Alternatively, when sampled frames whose quantity is equal to the foregoing difference are obtained in the two types of reorganized groups of pictures, the terminal may extract dependent frames of the sampled frames from the first-type reorganized group of pictures and the second-type reorganized group of pictures.

For example, as shown in FIG. 6, it is assumed that the 2^{nd} frame and the 4^{th} frame in FIG. 6 are sampled frames. Because a dependent frame of the 2^{nd} frame is an IDR frame, the dependent frame of the 2^{nd} frame does not need to be extracted. Because a dependent frame of the 4^{th} frame is the 3^{rd} frame, the 3^{rd} frame needs to be extracted. During decoding, the terminal only needs to decode the IDR frame and the 2^{nd} to 4^{th} frames, and does not need to decode the 1^{st} frame.

In the foregoing embodiment, the first-type group of pictures including the one or more instantaneous decoding refresh frames and the second-type group of pictures not including the one or more instantaneous decoding refresh frames are extracted from the to-be-processed video, and the non-reference frames are deleted from the first-type group of pictures and second-type group of pictures. In this way, decoding of the non-reference frames is effectively avoided, occupation of internal memory space is reduced, and video decoding efficiency is improved. In addition, in a video sparsification process, the one or more instantaneous decoding refresh frames are extracted from the first-type reorganized group of pictures, and sampling is performed on the first-type reorganized group of pictures from which the one or more instantaneous decoding refresh frames are extracted and the second-type reorganized group of pictures only when the quantity of the one or more instantaneous decoding refresh frames does not meet the decoding condition, to obtain the one or more sampled frames. Therefore, there is no need to decode all the reference frames of the to-be-processed video, and video frame decoding needs to be performed only on the sampled frame and the instantaneous decoding refresh frame, to obtain the decoded frame. Therefore, decoding calculation amount is further reduced, and video decoding efficiency is greatly improved. Moreover, on a premise that a quantity of required captured frames is fixed, the obtained decoded frame covers a core semantic of the to-be-processed video, so that, in a downstream application scenario, the decoded frame can be used to obtain a video processing result that represents the to-be-processed video and that has high accuracy.

In an embodiment, the terminal obtains a luminance vector, a first chrominance vector, and a second chrominance vector of the decoded frame. The terminal separately performs linear transformation on the luminance vector, the first chrominance vector, and the second chrominance vector, to obtain a decoded frame in a target format. In addition, after obtaining the decoded frame in the target format, the terminal may further obtain a target video based on the decoded frame in the target format.

A format of the decoded frame may be a YUV format, where Y represents luminance, and U and V represent chrominance. The target format may be a red, green, and blue (RGB) format or a blue, green, and red (BGR) format.

Linear transformation may be performed on Y, U, and V vectors, to convert the YUV format into the RGB format or the BGR format. A linear transformation formula is as follows:

$$R = Y + 1.403 * V ;$$

$$G = Y - 0.344 * U - 0.714 * V ;$$

$$B = Y + 1.77 * U .$$

In the foregoing embodiment, format conversion is performed on the decoded frame, to obtain the decoded frame in the target format, and the target video is obtained based on the decoded frame in the target format. In this way, the decoded frame is converted into a target video that can be used on a normal device.

After the decoded frame in the target format is obtained, the decoded frame may be applied to a corresponding application scenario, for example, applied to scenarios such as video understanding, gesture recognition, and content recognition. Specific application scenarios are described below.

Scenario 1: Application scenario of video understanding.

In an embodiment, a terminal classifies, in response to a video classification operation, the decoded frame by using a video classification model, to obtain a video type of the to-be-processed video. Because the decoded frame is a video frame in which all key information of the to-be-processed video is reserved, the target video is used for classification, to greatly reduce video classification duration and improve video classification efficiency.

The video classification operation may be an operation inputted by a user and configured for performing classification by using the decoded frame.

Specifically, the user may trigger the video classification operation on an operation page of a client. In this case, the terminal may input the decoded frame to the video classification model, and perform video understanding and classification on the decoded frame by using the video classification model, to obtain the video type of the to-be-processed video.

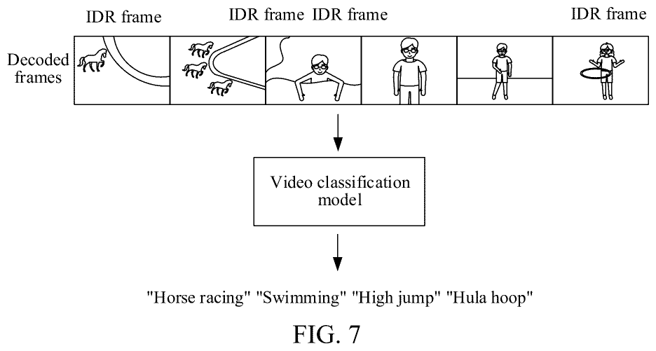

For example, as shown in FIG. 7, decoded frames obtained by performing sparsification on a to-be-processed sports video are inputted into a video classification model, and a type corresponding to the sports video may be outputted through understanding and classification by the video classification model. For example, the to-be-processed sports video is a video about “horse racing,” “swimming,” “high jump,” and “hula hoop” competitions.

Scenario 2: Application scenario of gesture recognition.

In an embodiment, a terminal performs, in response to a posture recognition operation, posture recognition on an object in a target video by using a video recognition model, to obtain posture information corresponding to the object. After obtaining the posture information, if the posture information satisfies a preset posture condition, the terminal may initiate an interaction procedure corresponding to a case in which the posture condition is satisfied, for example, photographing the object.

The object in the target video may be a human object. The posture recognition operation may be an operation inputted by a user through a terminal and configured for recognizing a posture. In addition, the posture recognition operation may alternatively be an operation that is triggered when the terminal detects a user through an associated device and that is configured for recognizing a posture. The associated device may be a device that establishes a connection to the terminal, such as an unmanned aerial vehicle or a robot.

For example, when detecting a human object, the unmanned aerial vehicle or the robot sends a start instruction to the terminal (such as a mobile phone). In this case, the posture recognition operation is triggered, and the terminal enters a posture recognition procedure. The unmanned aerial vehicle or the robot sends, to the terminal and in a form of a video stream, a to-be-processed video obtained by photographing the human object in real time. The terminal processes the to-be-processed video according to the video processing method of this application, to obtain a corresponding decoded frame, and then performs posture recognition on the human object in the decoded frame, to obtain corresponding posture information such as OK gesture information. If the human object poses an OK gesture, the OK gesture corresponds to a photographing parameter. When the OK gesture information is recognized by using the decoded frame, the terminal may perform photo capturing on the human object.

Scenario 3: Application scenario of content recognition.

In an embodiment, a terminal performs, in response to a content recognition operation, semantic recognition on the decoded frame by using a video processing model, to obtain video information corresponding to the to-be-processed video.

The video information may be video description information or object description information corresponding to a target object in a frame of the to-be-processed video.

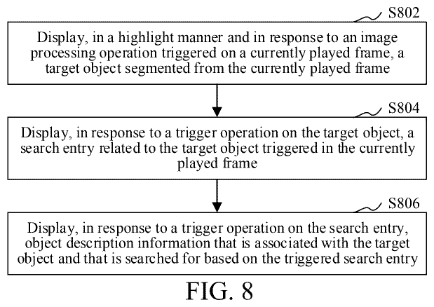

When the video information is the object description information, the terminal may input the decoded frame into the video processing model to perform semantic recognition, so as to obtain the corresponding object description information. In addition, alternatively, a user may select one of a plurality of target objects in a currently played frame for recognition and searching, to obtain the corresponding object description information. Referring to FIG. 8, operations may specifically include:

S802: In a process of playing the decoded frame, display, in a highlight manner and in response to an image processing operation triggered on a currently played frame, a target object segmented from the currently played frame.

The currently played frame is a currently played decoded frame. The target object is obtained through recognition and segmentation by using the video processing model.

The image processing operation may be a tap operation or a long-press operation on the currently played frame. The highlight manner may be a displaying manner that distinguishes the target object from other image content (such as a background) in the currently played frame. For example, a translucent mask whose size is consistent with that of the target object is placed above the target object, to distinguish the target object from the other image content in the currently played frame. The translucent mask may be a translucent white mask or a mask in another color.

The target object may be an object of interest in the currently played frame, including a human object, a static object, a graphic, or a text. In addition, the target object may alternatively include an animal, a plant, a building, a mountain, a river, or the like. The static object may include clothing worn by the human object, a handheld object, or an object placed nearby. The object placed nearby and the handheld object may be respectively an automobile, a mobile phone, a computer, a charger, a watch, food, a fruit, or the like. The clothing mentioned above may include clothes, pants, a hat, and another ornament that are worn.

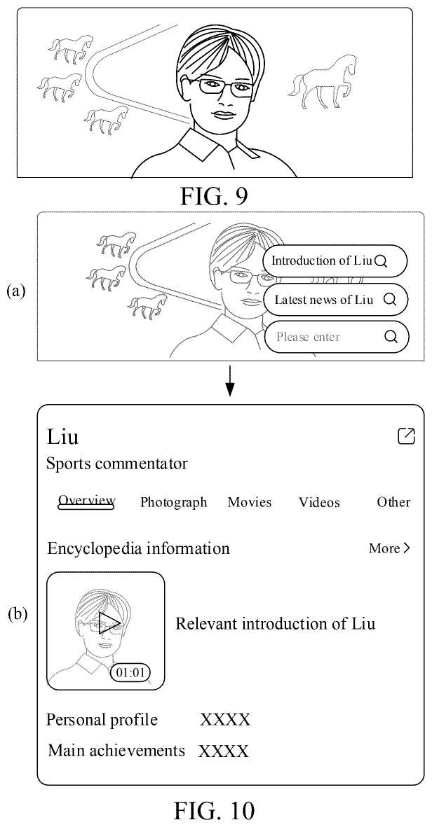

For example, for a sports video, as shown in FIG. 9, a currently played frame is a video frame currently played in the sports video. If a user likes a commentary style of a commentator in the current video frame, but does not know the commentator, the user may double-tap the currently played frame. In this case, a terminal detects a target object in the currently played frame, and then displays the target object in a highlight manner. When a plurality of target objects exist in the current video frame, all the target objects may be detected in a manner of target detection, and displayed in the highlight manner.

S804: Display, in response to a trigger operation on the target object, a search entry related to the target object triggered in the currently played frame.

The search entry may include a character or word that is directly related to the target object and that is used for searching, or may be a phrase formed by a character, a word, and the like that is used for searching and that is related to the target object. A quantity of search entries may be one or more, for example, one, two, or more than two. In addition, the search entry may further include a character or word that is indirectly related to the target object and that is used for searching, for example, a search word of another associated object derived based on the target object. As shown in part (a) in FIG. 10, assuming that the target object is a human object (for example, Liu), the search entry may be an introduction of Liu, latest news of Liu, or the like.

The trigger operation on the target object may be an operation of selecting the target object, for example, an operation of touching or tapping the target object.

When there are a plurality of target objects obtained through segmentation, a search entry related to a specific target object may be displayed based on an actual requirement. For example, if there is a target object a and a target object b, the target object a may be tapped or touched, and a search entry related to the target object a is displayed. Alternatively, the target object b may be tapped or touched, and a search entry related to the target object b may be displayed.

S806: Display, in response to a trigger operation on the search entry, object description information that is associated with the target object and that is searched for based on the triggered search entry.

The object description information may be public information of the target object, and the target object can be known based on the object description information. Alternatively, the object information is detailed information of another associated object derived based on the target object.

When there are a plurality of search entries, one of the search entries may be selected and triggered. As shown in part (a) in FIG. 10, the search entry “Introduction of Liu” is triggered. In addition, if a displayed search entry does not meet a requirement, an actually required search entry may be entered in a search box with reference to the displayed search entry, and then search is performed by using the entered search entry.

In an embodiment, a terminal searches, in response to a trigger operation on a search entry, for object description information of a target object based on the triggered search entry. In a search process, the terminal may jump from a current page to a search page. For example, the terminal jumps from a media page that displays media information to the search page. As shown in part (b) in FIG. 10, the object description information is displayed on the search page. The search page may be a page configured for displaying the object description information.

In addition to the foregoing three application scenarios, the video processing method of this application may alternatively be applied to any other scenario in which video decoding needs to be performed.

In the foregoing embodiments, in a process of playing a video, if content in a currently played frame needs to be searched for, an operation may be triggered on the currently played frame. In this case, a target object in the currently played frame is segmented and displayed in a highlight manner. In this way, during searching, the required target object can be selected, and a case in which the entire currently played frame needs to be searched is avoided. In addition, search entries related to the target object are also displayed, so that one of the search entries can be selected and searched for, to obtain object description information of the target object, so as to conduct a targeted search for the target object and in a desired search direction. Therefore, refined searching is implemented, accuracy of a searching result is improved, and a searching effect is improved. In addition, during searching, the currently played frame does not need to be manually inputted into a search engine for searching, thereby improving searching efficiency.

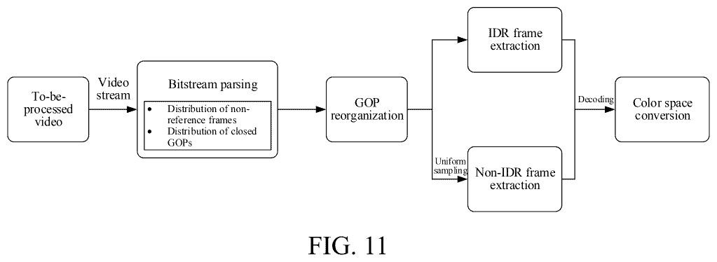

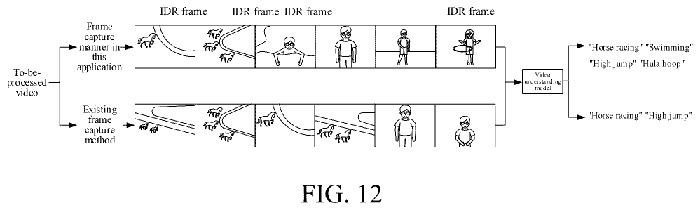

In an example, a solution of this application is described with reference to FIG. 3, FIG. 4, FIG. 5, FIG. 6, FIG. 11, and FIG. 12. Details are described below.

As shown in FIG. 11, bitstream parsing is first performed on a video stream of a to-be-processed video, to obtain distribution of non-reference frames and distribution of different types of GOPs, for example, distribution of closed GOPs and open GOPs. Then, non-reference frames in a GOP are decoupled and the GOP is reorganized, and two reference frames that are associated and that are adjacent to each other are bound. Next, IDR frames are preferentially extracted from a reorganized GOP, all the extracted IDR frames are combined into an IDR frame sequence, and remaining video frames in the reorganized GOP are combined into a non-IDR frame sequence. If a quantity of the IDR frames is less than a quantity of captured frames actually required by a user, uniform sampling is performed in the non-IDR frame sequence, and then the IDR frames, sampled frames, and dependent frames are decoded, to obtain decoded frames. Finally, color space conversion is performed on all the decoded frames, to convert formats of the decoded frames from a YUV format into a common RGB/BGR format.

### (1) Bitstream Parsing

In the video stream of the to-be-processed video, each video frame is encapsulated in a data packet. Content of the data packet includes, in addition to a frame type (namely, the I-frame, P-frame, and B-frame), attribute information such as nal_ref_idc and whether the video frame is an IDR frame. Distribution of each closed GOP may be determined based on the attribute information configured for determining whether the video frame is an IDR frame, and a non-reference frame may be selected based on nal_ref_idc (where nal_ref_idc=0 indicates a non-reference frame, and nal_ref_idc!=0 indicates a reference frame).

The 1^{st} frame of each GOP is an I-frame. If the 1^{st} frame is an IDR frame, the GOP is a closed GOP; otherwise, the GOP is an open GOP. For decoding of a frame in the open GOP, a decoding result of a previous GOP may need to be depended on. For example, referring to FIG. 3, decoding of the 14^{th} frame needs to depend on a decoding result of the 12^{th} frame. In addition, distribution of the non-reference frames may be obtained based on nal_ref_idc. For example, the 2^{nd} frame and 3^{rd} frame are non-reference frames, indicating that another frame does not need to depend on decoding results of the 2^{nd} frame and 3^{rd} frame during decoding. Therefore, discarding of the two frames does not affect a subsequent decoding process.

### (2) Bitstream Reorganization

Because a non-reference frame is similar to a picture of a neighboring reference frame, in this application, the non-reference frame is removed to implement decoupling. In this way, only decoding of the reference frame is considered during decoding, to reduce a redundant frame and improve decoding efficiency.

FIG. 4 shows a specific procedure of GOP reorganization. Using a closed GOP in FIG. 4 as an example, in this application, the non-reference frames are first decoupled, that is, the 2^{nd}, 3^{rd}, 5^{th}, 6^{th}, 9^{th}, and 10^{th} frames are discarded. Then video frames in a reorganized GOP are bound. For example, the 7^{th} frame is associated with the 4^{th} frame, so that a decoder decodes the 7^{th} frame after decoding the 4^{th} frame, instead of decoding the 2^{nd} and 3^{rd} frames.

### (3) IDR Frame Extraction

Generally, when video frames greatly differ in a video encoding process, the reference frame queue is cleared and an IDR frame is obtained through re-encoding, to prevent a coding error from spreading. In this application, the IDR frames are preferentially extracted, so that frames with large picture changes are retained as much as possible. As shown in FIG. 5, all the extracted IDR frames may form an IDR frame sequence.

Closed GOPs are independent of each other. Therefore, the 1^{st} frame (that is, an IDR frame) of each closed GOP may be directly decoded separately, and in a decoding process, video decoding may be performed in a parallel manner, to further increase a decoding speed. In addition, the IDR frames are preferentially decoded, so that internal memory access and decoding for another frame in the GOP can be reduced to increase the decoding speed.

### (4) Non-IDR Frame Extraction

When a quantity Iₙᵤₘ of IDR frames is less than a quantity N of required captured frames, sampling is performed on the non-IDR frame sequence to obtain a sufficient quantity of video frames. As shown in FIG. 5, after the non-IDR frame sequence is obtained, a quantity of non-IDR frames that need to be decoded is calculated as T=N−Iₙᵤₘ. Then, T video frames (which are subsequently referred to as sampled frames for ease of distinguishing) are uniformly sampled from the non-IDR frame sequence. Because the sampled frames may depend on other reference frames (which are referred to as dependent frames for short), the IDR frames, the sampled frames, and the corresponding dependent frames may be decoded to ensure complete decoding of the sampled frames.

As shown in FIG. 6, two sampled frames (for example, the 2^{nd} frame and 4^{th} frame) are obtained by performing uniform sampling on the non-IDR frame sequence. Because the dependent frame of the 2^{nd} frame is an IDR frame, and the dependent frame of the 4^{th} frame is the 3^{rd} frame, the 3^{rd} frame needs to be decoded before the sampled frames are decoded.

In this application, only the IDR frame, the sampled frame, and the corresponding dependent frame need to be decoded, and there is no need to first decode and buffer all the non-IDR frames and then perform uniform sampling. Therefore, internal memory consumption and decoding duration are greatly reduced.

After the non-reference frames in each GOP in the video stream are removed and the GOP is reorganized, a reorganized GOP is obtained. A new non-reference frame may appear in the reorganized GOP. In this case, removing may be performed twice to further reduce a redundant frame, so as to greatly improve decoding efficiency.

### (5) Color Space Conversion

A format of a decoded video frame is the YUV format, and color space needs to be converted into the common RGB/BGR format. Conversion from the YUV format to the RGB/BGR format may be implemented by performing linear transformation on the Y, U, and V vectors. A linear transformation formula is as follows:

$$R = Y + 1.403 * V ;$$

$$G = Y - 0.344 * U - 0.714 * V ;$$

$$B = Y + 1.77 * U .$$

### (6) An Example of Technical Application

This application, as a general method for sparsely capturing a frame in a video, may be applied to application scenarios such as video understanding, action recognition, and video content description. As shown in FIG. 12, a to-be-processed video is processed by using this solution of this application, to obtain a target video mainly including IDR frames, and further including sampled frames and dependent frames. Frames with large picture changes can be retained by using the IDR frames, to further facilitate a video processing task. In addition, a non-reference frame is removed to accelerate decoding, and a result of a decoded video frame is inputted into a specific video model for processing, for example, video understanding is performed to obtain a video type. It can be learned from FIG. 12 that, on a premise that a quantity of captured frames is fixed, all video clips in the to-be-processed video can be identified by using a frame capture manner of this application. However, not all the video clips in the to-be-processed video can be identified by using an existing frame capture method, resulting in low accuracy of video classification.

In this application, fast sparse frame capture of a video is implemented based on two angles, that is, non-reference frame removing and IDR frame extraction. In comparison with the existing method, advantages of this application are as follows:
(1) The non-reference frames are discarded to reduce redundant frames and increase a decoding speed.
(2) The IDR frames are preferentially decoded and the video frames with large picture changes are retained as much as possible, to ensure that a frame capture result can represent the entire to-be-processed video to the greatest extent.
(3) Only the sampled frame and the dependent frame of the sampled frame are decoded, to avoid problems of internal memory surge and low decoding efficiency caused by when all the frames are decoded.

Operations in flowcharts involved in the foregoing embodiments are shown sequentially based on indication of arrows, but the operations are not necessarily performed sequentially based on a sequence indicated by the arrows. Unless explicitly specified in this application, an execution sequence of the operations is not strictly limited, and the operations may be performed in other sequences. In addition, at least a part of the operations in the flowcharts involved in the foregoing embodiments may include a plurality of operations or a plurality of stages. These operations or stages are not necessarily performed simultaneously, but may be performed at different moments. These operations or stages are also not necessarily performed sequentially, but may be performed in turn or alternately with other operations or at least a part of operations or stages in the other operations.

Based on the same inventive concept, an embodiment of this application further provides a video processing apparatus configured to implement the foregoing related video processing method. An implementation solution provided by the apparatus for resolving a problem is similar to an implementation solution recorded in the foregoing method. Therefore, for specific limitations on one or more following embodiments of the video processing apparatus, refer to the limitations on the foregoing video processing method. Details are not described herein.

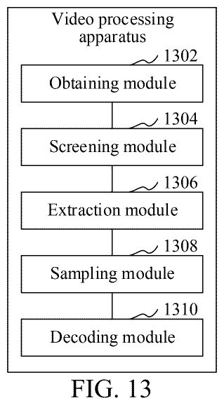

In an embodiment, as shown in FIG. 13, a video processing apparatus is provided, including an obtaining module 1302, a screening module 1304, an extraction module 1306, a sampling module 1308, and a decoding module 1310.

The obtaining module 1302 is configured to obtain video frame attribute information, a first-type group of pictures, and a second-type group of pictures from a to-be-processed video.

The screening module 1304 is configured to delete one or more non-reference frames in the first-type group of pictures and one or more non-reference frames in the second-type group of pictures based on the attribute information, to obtain a first-type reorganized group of pictures and a second-type reorganized group of pictures.

The extraction module 1306 is configured to extract one or more instantaneous decoding refresh frames from the first-type reorganized group of pictures, to obtain the one or more instantaneous decoding refresh frames and a target group of pictures not including the one or more instantaneous decoding refresh frames.

The sampling module 1308 is configured to perform sampling on the target group of pictures and the second-type reorganized group of pictures when a quantity of the one or more instantaneous decoding refresh frames does not meet a decoding condition, to obtain one or more sampled frames.

The decoding module 1310 is configured to perform video frame decoding on the one or more sampled frames and the one or more instantaneous decoding refresh frames to obtain one or more decoded frames.

In some of the embodiments, the attribute information includes first attribute information configured for distinguishing between the instantaneous decoding refresh frame and a non-instantaneous decoding refresh frame.

The obtaining module 1302 is further configured to parse the to-be-processed video to obtain the first attribute information and at least two groups of pictures; and perform group type recognition on the at least two groups of pictures based on the first attribute information, to obtain the first-type group of pictures including the one or more instantaneous decoding refresh frames and the second-type group of pictures including the one or more non-instantaneous decoding refresh frames.

In some of the embodiments, the obtaining module 1302 is further configured to determine position information of the one or more instantaneous decoding refresh frames based on the first attribute information; determine distribution information of different types of groups of pictures based on the position information of the one or more instantaneous decoding refresh frames; and select, based on the distribution information, the first-type group of pictures including the one or more instantaneous decoding refresh frames and the second-type group of pictures including the one or more non-instantaneous decoding refresh frames from the at least two groups of pictures.

In some of the embodiments, the attribute information includes second attribute information configured for distinguishing between a reference frame and a non-reference frame.

The selection module 1304 is further configured to find the one or more non-reference frames in the first-type group of pictures and the one or more non-reference frames in the second-type group of pictures based on the second attribute information; and delete the one or more non-reference frames in the first-type group of pictures and the one or more non-reference frames in the second-type group of pictures to obtain the first-type reorganized group of pictures and the second-type reorganized group of pictures.

In some of the embodiments, the selection module 1304 is further configured to delete the one or more non-reference frames in the first-type group of pictures, and establish a binding relationship for video frames in the first-type group of pictures from which the one or more non-reference frames are deleted, to obtain the first-type reorganized group of pictures; and delete the one or more non-reference frames in the second-type group of pictures, and establish a binding relationship for video frames in the second-type group of pictures from which the one or more non-reference frames are deleted, to obtain the second-type reorganized group of pictures.

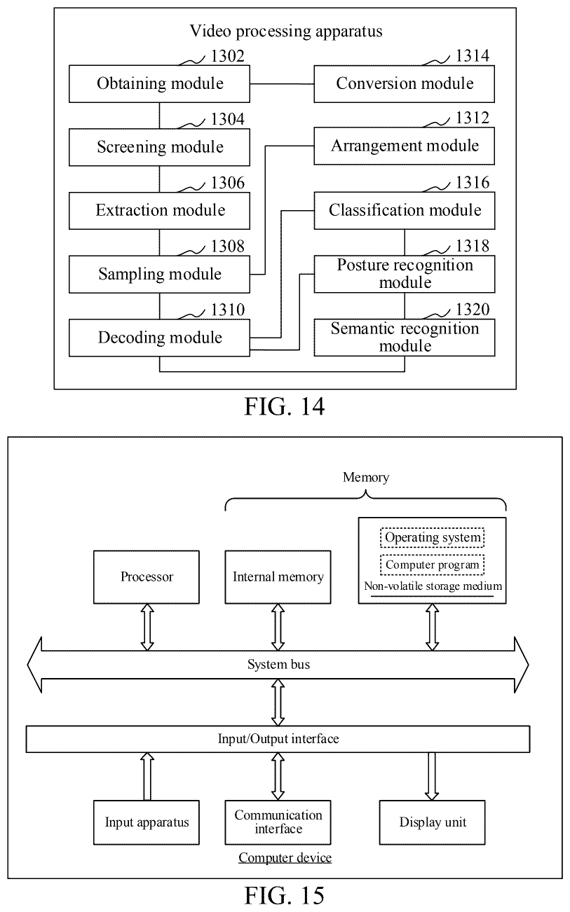

In some of the embodiments, as shown in FIG. 14, the apparatus further includes:

An arrangement module 1312, configured to combine the target group of pictures with the second-type reorganized group of pictures, to obtain a first video frame sequence; and

A sampling module 1308, further configured to when the quantity of the instantaneous decoding refresh frames is less than a preset frame quantity, determining a difference between the preset frame quantity and the quantity of the instantaneous decoding refresh frames; and perform sampling in the first video frame sequence based on the difference.

In some of the embodiments, the non-reference frame is a first-type non-reference frame.

The sampling module 1308 is further configured to determine one or more second-type non-reference frames in the first video frame sequence; delete the one or more second-type non-reference frames from the first video frame sequence, to obtain a new video frame sequence; and perform sampling in the new video frame sequence based on the difference.

In some of the embodiments, the extracted one or more instantaneous decoding refresh frames forms a second video frame sequence.

A decoding module 1310 is further configured to perform video frame decoding based on each instantaneous decoding refresh frame in the second video frame sequence when the quantity of the instantaneous decoding refresh frames meets the decoding condition, to obtain one or more decoded frames.

In some embodiments, the sampling module 1308 is further configured to, when the sampled frame has a corresponding dependent frame and the dependent frame and the instantaneous decoding refresh frame are not the same frame, extract the dependent frame of the sampled frame from at least one of the target group of pictures or the second-type reorganized group of pictures.

The decoding module 1310 is further configured to perform video frame decoding on the sampled frame, the instantaneous decoding refresh frame, and the dependent frame.

In some of the embodiments, a quantity of the instantaneous decoding refresh frames is at least two.

The decoding module 1310 is further configured to perform video frame decoding on the at least two instantaneous decoding refresh frames in a parallel manner; and sequentially perform video frame decoding on the dependent frame and the sampled frame in a serial manner.

In the foregoing embodiment, the first-type group of pictures including the one or more instantaneous decoding refresh frames and the second-type group of pictures not including the one or more instantaneous decoding refresh frames are extracted from the to-be-processed video, and the non-reference frames are deleted from the first-type group of pictures and second-type group of pictures. In this way, decoding of the non-reference frames is effectively avoided, occupation of internal memory space is reduced, and video decoding efficiency is improved. In addition, in a video sparsification process, the one or more instantaneous decoding refresh frames are extracted from the first-type reorganized group of pictures, and sampling is performed on the first-type reorganized group of pictures from which the one or more instantaneous decoding refresh frames are extracted and the second-type reorganized group of pictures only when the quantity of the one or more instantaneous decoding refresh frames does not meet the decoding condition, to obtain the one or more sampled frames. Therefore, there is no need to decode all the reference frames of the to-be-processed video, and video frame decoding needs to be performed only on the sampled frame and the instantaneous decoding refresh frame, to obtain the decoded frame. Therefore, decoding calculation amount is further reduced, and video decoding efficiency is greatly improved. Moreover, on a premise that a quantity of required captured frames is fixed, the obtained decoded frame covers a core semantic of the to-be-processed video, so that in a downstream application scenario, the decoded frame can be used to obtain a video processing result that represents the to-be-processed video and that has high accuracy.

In some of the embodiments, as shown in FIG. 14, the apparatus further includes:
the obtaining module 1302, further configured to obtain a luminance vector, a first chrominance vector, and a second chrominance vector of the decoded frame; and
a conversion module 1314, configured to separately perform linear transformation on the luminance vector, the first chrominance vector, and the second chrominance vector, to obtain a decoded frame in a target format.

In some of the embodiments, as shown in FIG. 14, the apparatus further includes:
a classification module 1316, configured to classify, in response to a video classification operation, a target video by using a video classification model, to obtain a video type of the target video.
a posture recognition module 1318, configured to perform, in response to a posture recognition operation, posture recognition on an object in the target video by using a video recognition model, to obtain posture information corresponding to the object; and
a semantic recognition module 1320, configured to perform, in response to a content recognition operation, semantic recognition on the target video by using a video processing model, to obtain video information corresponding to the target video.

In some of the embodiments, the video information includes object description information.

The semantic recognition module 1320 is further configured to: in a process of playing the target video, display, in a highlight manner and in response to an image processing operation triggered on a currently played frame of the target video, a target object segmented from the currently played frame; the target object being obtained through recognition and segmentation by using the video processing model; display, in response to a trigger operation on the target object, a search entry related to the target object triggered in the currently played frame; and display, in response to a trigger operation on the search entry, object description information that is associated with the target object and that is searched for based on the triggered search entry.

In the foregoing embodiment, after frame capture is performed on the to-be-processed video to obtain the decoded frame, classification and recognition are performed by using the decoded frame, to effectively improve classification and recognition efficiency on a premise of ensuring accuracy.

In addition, in a process of playing a video, if content in a currently played frame needs to be searched for, an operation may be triggered on the currently played frame. In this case, a target object in the currently played frame is segmented and displayed in a highlight manner. In this way, during searching, the required target object can be selected, and a case in which the entire currently played frame needs to be searched is avoided. In addition, search entries related to the target object are also displayed, so that one of the search entries can be selected and searched for, to obtain object description information of the target object, so as to conduct a targeted search for the target object and in a desired search direction. Therefore, refined searching is implemented, accuracy of a searching result is improved, and a searching effect is improved. In addition, during searching, the currently played frame does not need to be manually inputted into a search engine for searching, thereby improving searching efficiency.

The modules in the foregoing video processing apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs operations corresponding to each of the foregoing modules.

In an embodiment, a computer device is provided. The computer device may be a server or a terminal. Using the terminal as an example, FIG. 15 is a diagram showing an internal structure thereof. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The input/output interface of the computer device is configured to exchange information between the processor and an external device. The communication interface of the computer device is configured for wired or wireless communication with an external terminal. The wireless communication may be realized through Wi-Fi, a mobile cellular network, near-field communication (NFC), or another technology. The computer program is executed by the processor to implement a video processing method. The display unit of the computer device is configured to form a visually visible picture, and may be a display screen, a projection apparatus, or a virtual reality imaging apparatus. The display screen may be a liquid-crystal display screen or an electronic ink display screen. The input apparatus of the computer device may be a touch layer covering the display screen, or may be a button, a trackball, or a touch pad disposed on a housing of the computer device, or may be an external keyboard, a touch pad, a mouse, or the like.

A person skilled in the art may understand that, the structure shown in FIG. 15 is merely a block diagram showing a part of a structure related to a solution of this application and does not limit the computer device to which the solution of this application is applied. Specifically, the computer device may include more or fewer components than those in the drawings, or some components are combined, or a different component deployment is used.

In an embodiment, a computer device is provided, including a memory and a processor, the memory having a computer program stored therein, the processor, when executing the computer program, implementing operations of the video processing method.

In an embodiment, a computer-readable storage medium is provided, having a computer program stored therein, the computer program, when being executed by a processor, implementing operations of the video processing method.

In an embodiment, a computer program product is provided, including a computer program, the computer program, when being executed by a processor, implementing operations of the video processing method.

User information (including, but not limited to, user equipment information, user personal information, and the like) and data (including, but not limited to, data for analysis, stored data, displayed data, and the like) involved in this application both are information and data that are authorized by a user or fully authorized by all parties. Collection, use, and processing of related data need to comply with relevant laws and regulations of relevant countries and regions.

A person of ordinary skill in the art may understand that all or some of procedures of the method in the foregoing embodiments may be implemented by a computer program instructing relevant hardware. The computer program may be stored in a non-volatile computer-readable storage medium. When the computer program is executed, the procedures of the foregoing method embodiments may be implemented. Any reference to the memory, database, or another medium used in the embodiments provided in this application may all include at least one of a non-volatile or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM), an external cache, or the like. As an illustration rather than a limitation, the RAM may be in a plurality of forms, such as a static random access memory (SRAM) or a dynamic random access memory (DRAM). The database involved in the embodiments provided in this application may include at least one of a relational database and a non-relational database. The non-relational database may include a blockchain-based distributed database or the like, but is not limited thereto. The processor involved in the embodiments provided in this application may be a general-purpose processor, a central processing unit, a graphics processing unit, a digital signal processor, a programmable logic device, a quantum computing-based data processing logic device, or the like, but is not limited thereto.

Technical features in the foregoing embodiments may be combined in different manners to form other embodiments. For concise description, not all possible combinations of the technical features in the embodiments are described. However, the combinations of these technical features shall be considered as falling within the scope recorded by this specification provided that no conflict exists.

The foregoing embodiments only describe several implementations of this application, and are described in detail, but they should not be construed as a limitation to the patent scope of this application. A person of ordinary skill in the art may make various changes and improvements without departing from the ideas of this application, which shall all fall within the protection scope of this application. Therefore, the protection scope of this application is subject to the appended claims.

What is claimed is:

1. A video processing method, performed by a computer device, comprising:
obtaining video frame attribute information, a first-type group of pictures (GOP), and a second-type GOP from a video;
deleting one or more non-reference frames in the first-type GOP and one or more non-reference frames in the second-type GOP based on the attribute information, to obtain a first-type reorganized GOP and a second-type reorganized GOP;
extracting one or more instantaneous decoding refresh frames from the first-type reorganized GOP, to obtain the one or more instantaneous decoding refresh frames and a target GOP not including the one or more instantaneous decoding refresh frames;
performing sampling on the target GOP and the second-type reorganized GOP in response to a quantity of the one or more instantaneous decoding refresh frames not meeting a decoding condition, to obtain one or more sampled frames; and
performing video frame decoding on the one or more sampled frames and the one or more instantaneous decoding refresh frames to obtain one or more decoded frames.

2. The method according to claim 1, wherein obtaining the attribute information, the first-type GOP, and the second-type GOP from the video includes:
parsing the video to obtain the attribute information and at least two GOPs; and
performing group type recognition on the at least two GOPs based on the attribute information, to obtain the first-type GOP including the one or more instantaneous decoding refresh frames and the second-type GOP including one or more non-instantaneous decoding refresh frame.

3. The method according to claim 2, wherein performing group type recognition on the at least two GOPs includes:
determining position information of the one or more instantaneous decoding refresh frames based on the attribute information;
determining distribution information of different types of GOPs based on the position information; and
selecting, based on the distribution information, the first-type GOP and the second-type GOP from the at least two GOPs.

4. The method according to claim 1, wherein deleting the one or more non-reference frames in the first-type GOP and the one or more non-reference frames in the second-type GOP based on the attribute information includes:
finding the one or more non-reference frames in the first-type GOP and the one or more non-reference frames in the second-type GOP based on the attribute information; and
deleting the one or more non-reference frames in the first-type GOP and the one or more non-reference frames in the second-type GOP to obtain the first-type reorganized GOP and the second-type reorganized GOP.

5. The method according to claim 4, wherein deleting the one or more non-reference frames in the first-type GOP and the one or more non-reference frames in the second-type GOP to obtain the first-type reorganized GOP and the second-type reorganized GOP includes:
deleting the one or more non-reference frames in the first-type GOP, and then establishing a binding relationship for remaining video frames in the first-type GOP, to obtain the first-type reorganized GOP; and
deleting the one or more non-reference frames in the second-type GOP, and then establishing a binding relationship for remaining video frames in the second-type GOP, to obtain the second-type reorganized GOP.

6. The method according to claim 1, further comprising, after extracting the one or more instantaneous decoding refresh frames from the first-type reorganized GOP:
combining the target GOP with the second-type reorganized GOP, to obtain a video frame sequence;
wherein performing sampling on the target GOP and the second-type reorganized GOP in response to the quantity of the one or more instantaneous decoding refresh frames not meeting the decoding condition includes:
in response to the quantity of the instantaneous decoding refresh frames being less than a preset frame quantity, determining a difference between the preset frame quantity and the quantity of the one or more instantaneous decoding refresh frames; and
performing sampling in the video frame sequence based on the difference.

7. The method according to claim 6, wherein:
the one or more non-reference frames are one or more first-type non-reference frames; and
performing sampling in the video frame sequence based on the difference includes:
determining one or more second-type non-reference frames in the video frame sequence;
deleting the one or more second-type non-reference frames from the video frame sequence, to obtain a new video frame sequence; and
performing sampling in the new video frame sequence based on the difference.

8. The method according to claim 1, further comprising:
performing video frame decoding based on each instantaneous decoding refresh frame in a video frame sequence formed by the one or more instantaneous decoding refresh frames in response to the quantity of the one or more instantaneous decoding refresh frames meeting the decoding condition, to obtain the one or more decoded frames.

9. The method according to claim 1,
wherein the one or more sampled frames include one sampled frame having a corresponding dependent frame that is not any of the one or more instantaneous decoding refresh frames;
the method further comprising:
extracting the dependent frame from at least one of the target GOP or the second-type reorganized GOP;
wherein performing video frame decoding on the one or more sampled frames and the one or more instantaneous decoding refresh frames includes:
performing video frame decoding on the one or more sampled frames, the one or more instantaneous decoding refresh frames, and the dependent frame.

10. The method according to claim 9, wherein:
the one or more instantaneous decoding refresh frames include at least two instantaneous decoding refresh frames; and
performing video frame decoding on the one or more sampled frames, the one or more instantaneous decoding refresh frames, and the dependent frame includes:
performing video frame decoding on the at least two instantaneous decoding refresh frames in a parallel manner; and
sequentially performing video frame decoding on the dependent frame and the one sampled frame in a serial manner.

11. The method according to claim 1, further comprising, for one decoded frame of the one or more decoded frames:
obtaining a luminance vector, a first chrominance vector, and a second chrominance vector of the one decoded frame; and
separately performing linear transformation on the luminance vector, the first chrominance vector, and the second chrominance vector, to transform the one decoded frame to a target format.

12. The method according to claim 1, further comprising:
classifying, in response to a video classification operation, at least one of the one or more decoded frames using a video classification model, to obtain a video type of the video.

13. The method according to claim 1, further comprising:
performing, in response to a posture recognition operation, posture recognition on an object in at least one of the one or more decoded frames using a video recognition model, to obtain posture information corresponding to the object.

14. The method according to claim 1, further comprising:
performing, in response to a content recognition operation, semantic recognition on at least one of the one or more decoded frames using a video processing model, to obtain video information corresponding to the video.

15. The method according to claim 14, wherein:
the video information includes object description information; and
performing, in response to the content recognition operation, semantic recognition on the at least one of the one or more decoded frames includes:
in a process of playing the one or more decoded frames, displaying, in a highlight manner and in response to an image processing operation triggered on a currently played frame, a target object segmented from the currently played frame, the currently played frame being one of the one or more decoded frames that is currently being played, and the target object being obtained through recognition and segmentation using the video processing model;
displaying, in response to a trigger operation on the target object, a search entry related to the target object triggered in the currently played frame; and
displaying, in response to a trigger operation on the search entry, object description information that is associated with the target object and that is searched for based on the triggered search entry.

16. A computer device comprising:
a processor; and
a memory storing a computer program that, when executed by the processor, causes the processor to:
obtain video frame attribute information, a first-type group of pictures (GOP), and a second-type GOP from a video;
delete one or more non-reference frames in the first-type GOP and one or more non-reference frames in the second-type GOP based on the attribute information, to obtain a first-type reorganized GOP and a second-type reorganized GOP;
extract one or more instantaneous decoding refresh frames from the first-type reorganized GOP, to obtain the one or more instantaneous decoding refresh frames and a target GOP not including the one or more instantaneous decoding refresh frames;
perform sampling on the target GOP and the second-type reorganized GOP in response to a quantity of the one or more instantaneous decoding refresh frames not meeting a decoding condition, to obtain one or more sampled frames; and
perform video frame decoding on the one or more sampled frames and the one or more instantaneous decoding refresh frames to obtain one or more decoded frames.

17. The computer device according to claim 16, wherein the computer program when executed by the processor, further causes the processor to, when obtaining the attribute information, the first-type GOP, and the second-type GOP from the video:
parse the video to obtain the attribute information and at least two GOPs; and
perform group type recognition on the at least two GOPs based on the attribute information, to obtain the first-type GOP including the one or more instantaneous decoding refresh frames and the second-type GOP including one or more non-instantaneous decoding refresh frame.

18. The computer device according to claim 17, wherein the computer program when executed by the processor, further causes the processor to, when performing group type recognition on the at least two GOPs:
determine position information of the one or more instantaneous decoding refresh frames based on the attribute information;
determine distribution information of different types of GOPs based on the position information; and
select, based on the distribution information, the first-type GOP and the second-type GOP from the at least two GOPs.

19. The computer device according to claim 16, wherein the computer program when executed by the processor, further causes the processor to, when deleting the one or more non-reference frames in the first-type GOP and the one or more non-reference frames in the second-type GOP based on the attribute information:
find the one or more non-reference frames in the first-type GOP and the one or more non-reference frames in the second-type GOP based on the attribute information; and
delete the one or more non-reference frames in the first-type GOP and the one or more non-reference frames in the second-type GOP to obtain the first-type reorganized GOP and the second-type reorganized GOP.

20. A non-transitory computer-readable storage medium storing a computer program that, when executed by the processor, causes the processor to:
obtain video frame attribute information, a first-type group of pictures (GOP), and a second-type GOP from a video;
delete one or more non-reference frames in the first-type GOP and one or more non-reference frames in the second-type GOP based on the attribute information, to obtain a first-type reorganized GOP and a second-type reorganized GOP;
extract one or more instantaneous decoding refresh frames from the first-type reorganized GOP, to obtain the one or more instantaneous decoding refresh frames and a target GOP not including the one or more instantaneous decoding refresh frames;
perform sampling on the target GOP and the second-type reorganized GOP in response to a quantity of the one or more instantaneous decoding refresh frames not meeting a decoding condition, to obtain one or more sampled frames; and
perform video frame decoding on the one or more sampled frames and the one or more instantaneous decoding refresh frames to obtain one or more decoded frames.
